(19) United States
(12) Patent Application Publication
(10) Pub. No.: US 2004/0112454 A1
(43) Pub. Date: Jun. 17, 2004

(54) Metallic tubular hose

(76) Inventor: Yuji Takagi, Komaki-shi (JP)

Correspondence Address: Eugene Lieberstein, Esq., Anderson Kill & Olick, P.C., 1251 Avenue of the Americas, New York, NY, 10020, US

(21) Appl. No.: 10/730,466

(22) Filed: Dec. 8, 2003

(30) Foreign Application Priority Data
Dec. 6, 2002 (JP) 2002-355931

(51) Int. Cl. F16L 11/00

(52) U.S. Cl. 138/139; 138/143; 138/127

(57) ABSTRACT

The hose of the present invention comprising: a hose body 12 having an inner layer composed of a bellow metallic tube 22 and a jacket of at least one outer layer, with the hose body having a longitudinal edge at one end thereof; an insert pipe 14 extending longitudinally into the hose body 12 and a metallic sleeve 16 compressing the jacket against the insert pipe 14 at each of a plurality of pressure points disposed axially along the longitudinal edge of the hose body from said one end with said bellow metallic tube having a restricted end portion at one end thereof located forward of the last pressure point. The bellows metallic tube preferably has a straight tube portion integral to the bellows metallic tube for representing the restricted end portion thereof.

### FIELD OF THE INVENTION

The present invention relates to a metallic tubular hose comprising a bellows metallic tubular layer (hereinafter referred to as “bellows metallic tube”) suitable for transporting automotive fuels, coolants, or other types of fluids.

### BACKGROUND OF THE INVENTION

It is conventional to fabricate a hose from a composition of “NBR PVC” corresponding to a mixture of acrylonitrile butadiene rubber and polyvinyl chloride. A hose of this composition is typically used for transporting automotive fuels such as gasoline having low permeability. Regulation of the permeability properties of hoses in view of global environmental protection is expected to be imposed in the future. Moreover, a growing demand for a highly permeable fluid such as hydrogen gas or carbon oxide gas for a fuel cell is expected to obsolete a hose composed solely of an organic material (e.g. rubber, resin).

A hose comprising a bellows metallic tube in theory should permeate no fluid and should therefor be suitable for transporting fluids of very high permeability. Accordingly, even when hydrogen gas is used for a fuel cell, the permeability to hydrogen gas of a bellows metallic tube is “0,” providing complete protection against leakage.

Hoses comprising a bellows metallic tube are known to the prior art as taught and described in Japanese patent publication No's: (1) Japanese Unexamined Patent (Kokai) No. 2001-182872; (2) U.S. Pat. No. 6,631,741; and (3) Japanese Unexamined Utility Model (Jikkai) No. S51-150511.

FIG. 4 is a diagram depicting one embodiment of a hose comprising a bellows metallic tube to be used herein as a comparative example in the explanation of the subject invention.

FIG. 4 has hose body 200 shown in a cross section comprising a plurality of laminated layers with a bellows metallic tube 202 forming the innermost layer; an elastic layer 204 laminated in a radial direction over the bellows metallic tube 202; a reinforcing layer 206 laminated over the elastic layer 204; and an outer layer 208 laminated over the reinforcing layer 206.

Reference Number 210 is a metallic sleeve shown externally mated to a longitudinal edge at one end of the hose body 200. This is preferably accomplished by compressing the sleeve 210 at multiple pressure points P₁, P₂, P₃, and P₄, spaced apart in an axial direction along the longitudinal edge of the hose body 200, against a rigid insert pipe 212 using, for example, a crimping tool.

The metallic sleeve 210 compresses the longitudinal edge of the hose body 200 both inwardly and outwardly to hold the hose body 200 secure between the rigid insert pipe 212 and the metallic sleeve 210.

The hose body 200 includes an inner layer of a bellows metallic tube 202 having a corrugated portion 222 (“corrugated tube”) and an integral non-corrugated straight portion 214 (“straight tube”) extending axially from the corrugated tube portion 222. The straight tube 214 is externally mated to the insert pipe 212 upon crimping the sleeve 210.

The straight tube 214 has a section 216 (“extended section”) which extends outwardly from the hose body 200 in an axial direction. The metallic sleeve 210 includes a flange 218 which abuts the longitudinal edge of the hose body 200 and extends transverse to the axial direction into a groove 220 formed in the rigid insert pipe 212 so that upon crimping the sleeve 210 against the pipe 212, the straight tube 214 will deform within the groove 220 to prevent sliding of the straight tube 214 in an axial direction.

Note that the diameter “Dc” of the straight tube 214 is essentially equal to the maximum outer diameter of the corrugated tube 222 when the corrugated tube 222 is contracted and corresponds, at such time, to the peak to peak undulations “Da” as is illustrated in FIG. 5(A).

The bellows metallic tube portion 222 in the hose body 200 stretches in an axial direction upon application of internal pressurization as illustrated in FIG. 5(B).

When pressurized, the pitch of the bellows metallic tube portion 222 expands in an axial direction as indicated in the two-dot chain line illustrated in FIG. 6A, with peaks 222a shrinking and valleys 222b expanding. In other words, peaks 222a and valleys 222b shrink or expand to provide a mean diameter corresponding to the mean value of the diameters of peaks 222a and the valleys 222b of the bellows portion 222.

In contrast, the straight tube section 214 does not deform in a radial direction when it is internally pressurized. The result of internal pressurization is shown in FIG. 6(B) illustrating a step gradient between the straight tube 214 portion and the adjacent bellows tube portion 202 which causes a large local area of deformation or stress on the bellows tube portion 202, specifically at the juncture between the straight tube 214 and the bellows tube portion 202. The same phenomenon is observed in the pressurizing tests in which the hose is repeatedly pressurized internally. Distortion occurs at the point of stress and particularly at the first and second peaks 222a or valleys 222b in the corrugated tube 222 closest to the straight tube 214 where the distortion from stress is the largest.

The above description applies to any hose construction having a straight tube 214 secured at the longitudinal edge of the bellows metallic tube 202 even if, as an alternative, the straight tube 214 is (1) directly welding at the longitudinal edge of the bellows portion 222 to the insert pipe 212; (2) modified to form an imperfect bellows portion with a larger peak-to-peak pitch than the pitch of the corrugated tube 222 while the differential diameter between peaks and valleys is made smaller. The above alternatives will cause the same stress problem as long as it functions to form a restricting portion at the longitudinal edge of the hose body 200.

Although the above examples relate primarily to hoses for transporting hydrogen gas for use in fuel cells the same problems apply in all hose applications including (1) transporting a fuel (e.g. gasoline), where a hose is exposed to high temperature and high pressure (where low-gasoline permeability becomes a crucial issue) to protect air from gasoline contamination or to provide larger outputs from equipment; (2) transporting carbon dioxide in the form of a fluid, whose molecular weight is small, resulting in high permeability; and (3) other fields of technology where gas permeability regulations are stringent.

### SUMMARY OF THE INVENTION

The hose of the present invention comprises a bellows metallic tube of a construction which overcomes the stress problems identified above.

The hose of the present invention comprises: a hose body having an inner layer composed of a bellow metallic tube and a jacket of at least one outer layer, with the hose body having a longitudinal edge at one end thereof; an insert pipe extending longitudinally into the hose body and a metallic sleeve compressing the jacket of the bellows metallic tube against the insert pipe at each of a plurality of pressure points disposed axially along the longitudinal edge of the hose body from said one end with said bellow metallic tube having a restricted end portion at one end thereof located forward of the last pressure point. More particularly, the restricted end portion of said bellow metallic tube lies at a located between the pressure point closest to the longitudinal edge end of the hose body and the last pressure point.

In the preferred embodiment the bellows metallic tube has a straight tube portion integral to the bellows metallic tube representing the restricted end portion of the bellows metallic tube and should extend from one end of the hose body to a point between the pressure point closest to such end and the last pressure point.

It is a further feature of the present invention wherein the rigid insert pipe is inserted into the hose body and includes one section upon which the straight tube portion is mounted and another section represented by a tip which further extends axially and upon which at least part of the bellows metallic tube is mounted.

It is yet a further feature of the present invention for the insert pipe to have a first section upon which the straight tube portion is mounted and a radial thickness which is larger than the radial thickness of the tip extending axially therefrom.

It is yet an even further feature of the present invention for the insert pipe to have a series of projections radially extending from the outer circumference of the tip of the insert pipe which mesh with the inner grooves formed by the corrugations on the inner circumference of the bellows tube.

### ADVANTAGES OF THE INVENTION

In accordance with the present invention, the outer end of the bellows metallic tube at the juncture where the restricted end portion, i.e., the straight tube portion is compressed in a radial direction to restrict the movement of the bellows metallic tube. Consequently, restricting the movement of the bellows metallic tube, particularly at the juncture forming the restricted end portion, i.e. the straight tube restricts stretching or shrinking in an axial direction at the restricted end thereof.

Even though the bellows metallic tube stretches or shrinks in an axial direction as the internal tube is pressurized, stretching or shrinkage at the restricted end of the bellow metallic tube is suppressed. As a result minimal distortion occurs at the restricted end of the bellows metallic tube.

In this invention, the juncture between the bellows metallic tube and the straight tube portion is located at a point along the longitudinal edge of the hose body between a pressure point at one end of the hose body and the last pressure point axially displaced from such end.

The preferred location for the restricted end of the bellows metallic tube at the juncture with the straight tube should correspond to a distance of at least three pitches or 25 mm in the axial direction forward or ahead of the last pressure point.

Positioning the restricting portion to a position ahead of the last pressure point along the metallic sleeve suppresses distortion and stress on the corrugations nearest the juncture with the straight tube.

It is desirable for the tip of the rigid insert pipe to be inserted into the corrugated bellows portion. This causes the outer layer outside the edge of the bellows portion to be further pressed between the insert pipe and metallic sleeve which, in turn, suppresses movement at the edge which minimizes deformation at the edge of the bellows portion.

When the tip of the insert pipe is inserted into the corrugated bellows portion, the tip may have projections on the outer circumference thereof which will mesh with grooves formed by the corrugated bellows portion on the inner circumference to prevent the insert pipe from shifting in the axial direction.

The present invention is suitable for the bellows metallic tube configuration illustrated in FIG. 4, wherein the restricting portion is the longitudinal straight tube 214 integrally formed with the bellows metallic tube.

The present invention is also applicable to a bellows metallic tube which is welded or otherwise joined to an insert pipe or wherein the insert pipe has an imperfect bellows portion formed integral with the longitudinal edge end of the bellows metallic tube to constitute the restricting portion.

### BRIEF DESCRIPTION OF THE DRAWINGS

FIG. 1A is a pictorial illustration of the preferred embodiment of the hose of the present invention.

FIG. 1B is a isometric of the bellows metallic tube in the hose of FIG. 1A.

FIG. 1C is a cross sectional view of the laminated layers of the bellows tube of FIG. 1B.

FIG. 2A is a cross sectional side view of the hose embodiment of FIG. 1.

FIG. 2B is an enlarged view of a section of the corrugated bellows portion and insert pipe in FIG. 2.

FIG. 3A is a cross section of an alternate embodiment of the present invention.

FIG. 3B is an enlarged view similar to FIG. 2B showing a modified version of the insert pipe and its relationship to the corrugations in the bellows metallic tube.

FIG. 4 is a diagram depicting a less preferred bellows metallic tube hose configuration of the subject invention presented for comparative analysis.

FIG. 5(A) is a diagram illustrating the bellows metallic tube of FIG. 4 when fully contracted.

FIG. 5(B) is a diagram illustrating the bellows metallic tube of FIG. 4 when stretched.

FIG. 6(A) is a diagram illustrating the changing pitch in the hose of FIG. 4 when it is stretched; and

FIG. 6(B) is a diagram illustrating the problem of stress developing as a gradient resulting from the changing pitch of the hose in FIG. 6(A) at the juncture between the corrugated portion of the bellows metallic tube and the straight tube portion.

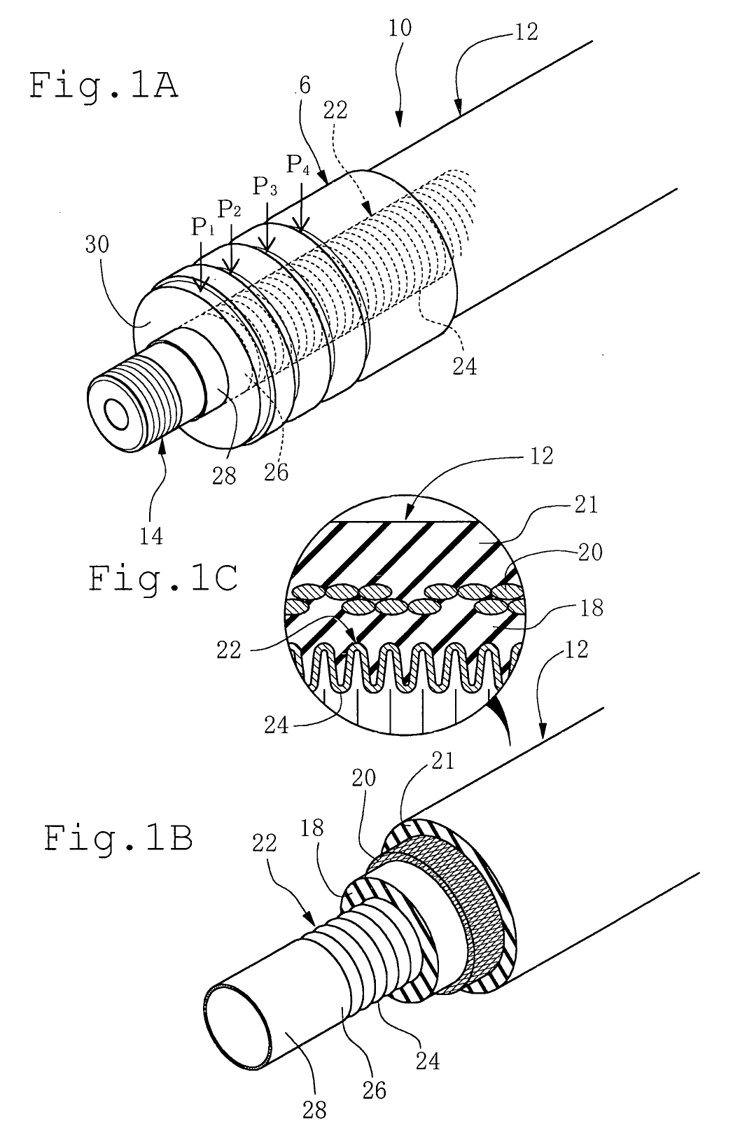

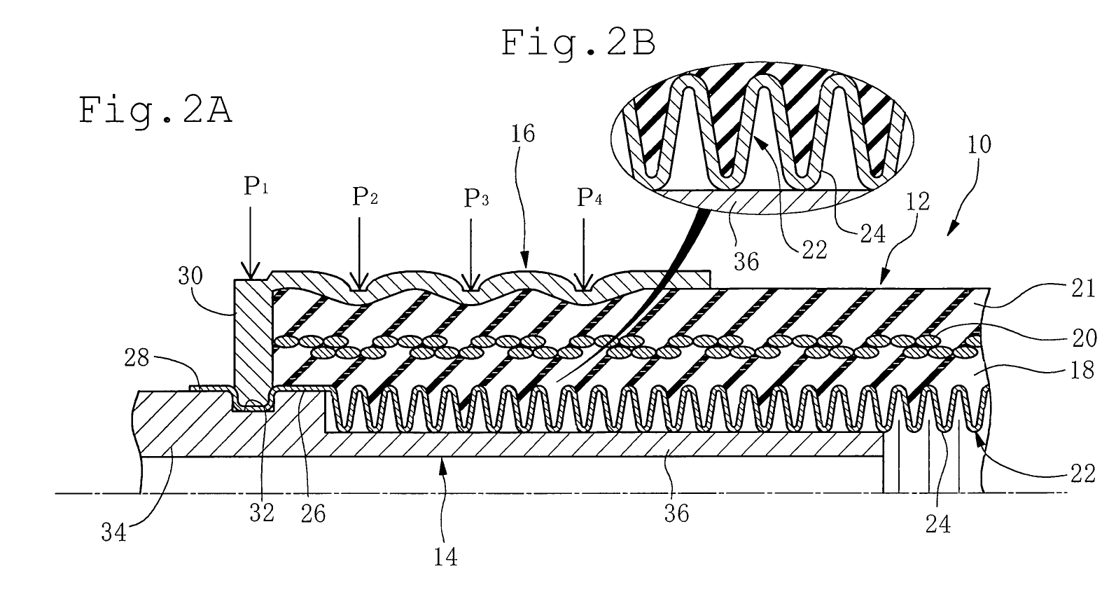

### EMBODIMENTS

Embodiments of the present invention are described herein with reference to the drawings.

In the figures reference number 10 designates a metallic tubular hose (hereinafter referred to as “hose”) suitable for hydrogen transport, automobile fuel transport, air conditioning coolant transport, and the like; 12 is the hose body, 14 is a hollow metallic insert pipe fixed onto the hose body 12; and 16 is a metallic sleeve externally mated to the longitudinal edge of the hose body 12.

Metallic sleeve 16 is compressed inwardly in a radial direction at four pressure points P₁, P₂, P₃, and P₄ which are axially displaced along the longitudinal edge of the hose body 12 from one end thereof in such a manner that the metallic sleeve 16 is mated to the insert pipe 14 to secure the hose body 12 in place.

The hose body 12 comprises: an inner layer formed of a bellows metallic tube 22; an elastic outer layer 18; a reinforcing layer 20; and an outer elastic cover layer 21 with the elastic layer 18 integrally bonded to the metallic tube by a vulcanizing adhesive or the like.

In this embodiment, the inner elastic layer, reinforcing layer 20, and the outer elastic layer 21 together constitute a jacket for the bellows metallic tube 22.

The reinforcing layer 20 is composed of braided wires wrapped in opposite directions e.g. wrapped alternately and at a given angle around the inner layer 18.

The inner elastic layer 18 and the outer elastic layer 21 are preferably composed of an elastic material such as rubber or the like.

The hose body 12 may be formed with the innermost layer comprised solely of a bellows metallic tube 22 in an axial direction or formed integral with a straight tube portion 26 extending therefrom to the longitudinal edge end of the hose body 12. Accordingly, even though the innermost layer of the hose body 12 is a metallic tube the hose 10 is flexible as a whole due to the bellows portion of the metallic tube.

Desirable materials for the bellows metallic tube 22 include steel (including stainless steel), copper, copper alloys, aluminum, aluminum alloys, nickel, nickel alloys, titanium, titanium alloys, and the like. Among these, stainless steel is most desirable material.

The thickness of the stainless steel may be 20-500 μm, however, 50 μm or more is desirable for protection of the bellows corrugated portion 24 as shown in the figures against defects (e.g. pin holes) and to facilitate maintenance and machinability of the metallic tube 10.

The bellows metallic tube 22 comprises a bellows corrugated portion 24 and an integrally formed straight portion (“straight tube”) 26 axially extending therefrom. The straight tube 26 is affixed to the insert pipe 14.

The straight tube 26 has a section 28 which extends outwardly in an axial direction from the hose body 12. The metallic sleeve 16 has a flange 30 extending transverse to the hose body 12 in abutment to the longitudinal edge end of the hose body 12. The insert pipe 34 has a groove 32 into which the flange 30 is seated so that upon compressing the metallic sleeve 16 against the insert pipe 14 the flange 30 deforms the straight tube 26 in the groove 32 which prevents the straight tube 26 from sliding in an axial direction.

The straight tube 26 operates as the restriction portion of the bellows metallic tube 22 in this embodiment of the present invention.

Insert pipe 14 comprises a tubular base 34 having an extended tip 36 of tubular geometry with a diameter smaller than the diameter of the base 34. The base includes a groove 32 into which the flange 30 is seated and extends along the longitudinal edge of the body 12 for mounting the straight tube 26 portion. The tip 36 extends into the bellows portion 24 and serves as a platform upon which the bellows portion 24 is mounted.

The sleeve 16 is compressed against the insert pipe 34 to impart a force at each of the axial positions P₁, P₂, P₃ and P₄. Since the tip 36 has a smaller diameter, the positions P₂, P₃, and P₄ will impart a larger force.

In this embodiment, the straight tube 26 extends from the end of the body 12 at the flange 30 and meets the forward edge of the bellows portion 24 at a location ahead of position P₄.

More specifically, the straight tube 26 should be of a length extending from the end of the body 12 at the flange 30 to a position before the last position P₄.

It is more preferable for the straight tube 26 to be of a length extending a distance of at least three pitches or 25 mm in the axial direction before the last position P₄.

Even though the bellows metallic tube 22 stretches or shrinks in an axial direction when the internal tube is pressurized, stretching or shrinkage at the restricted end of the bellows portion 24 is suppressed.

The tip 36 of the insert pipe 14 is also inserted within the bellows portion 24 to minimize deviation or deformation of the edge of the bellows portion 24.

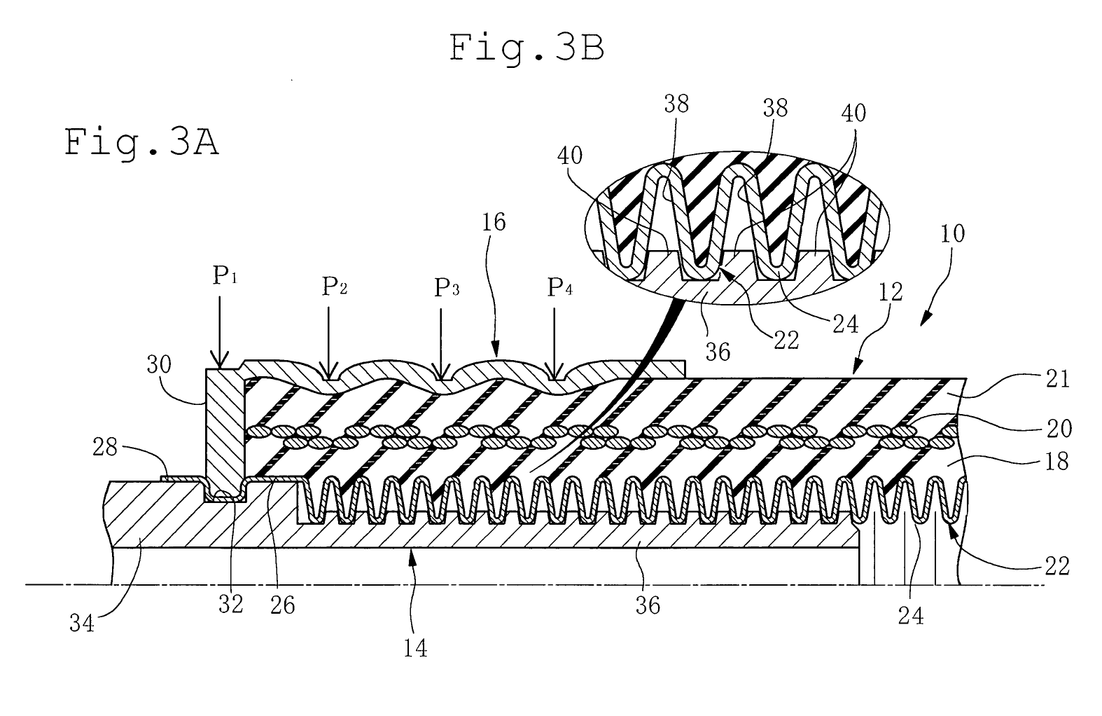

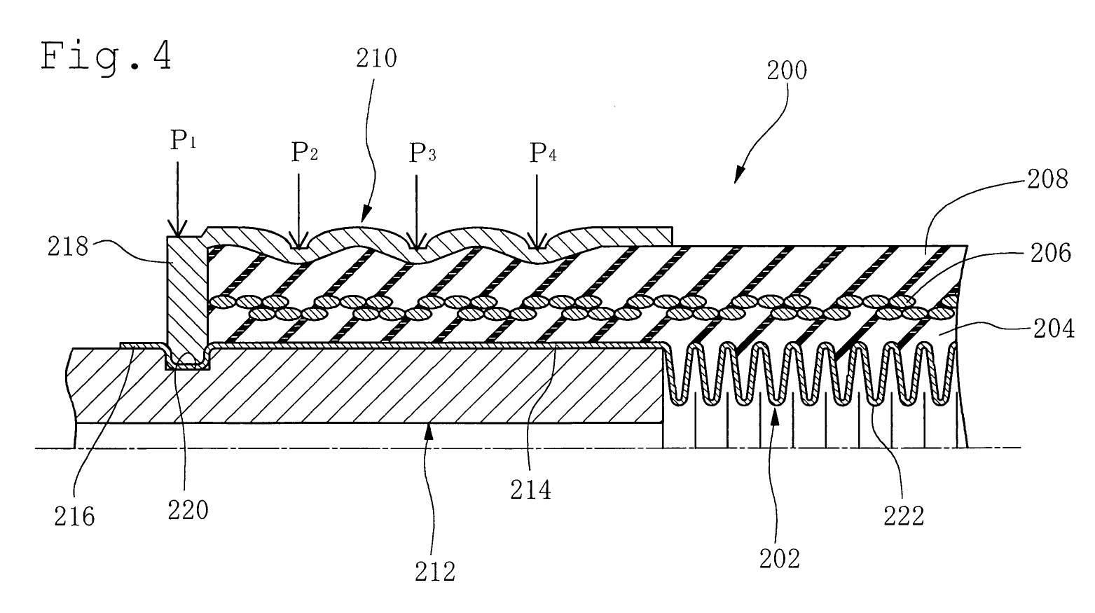

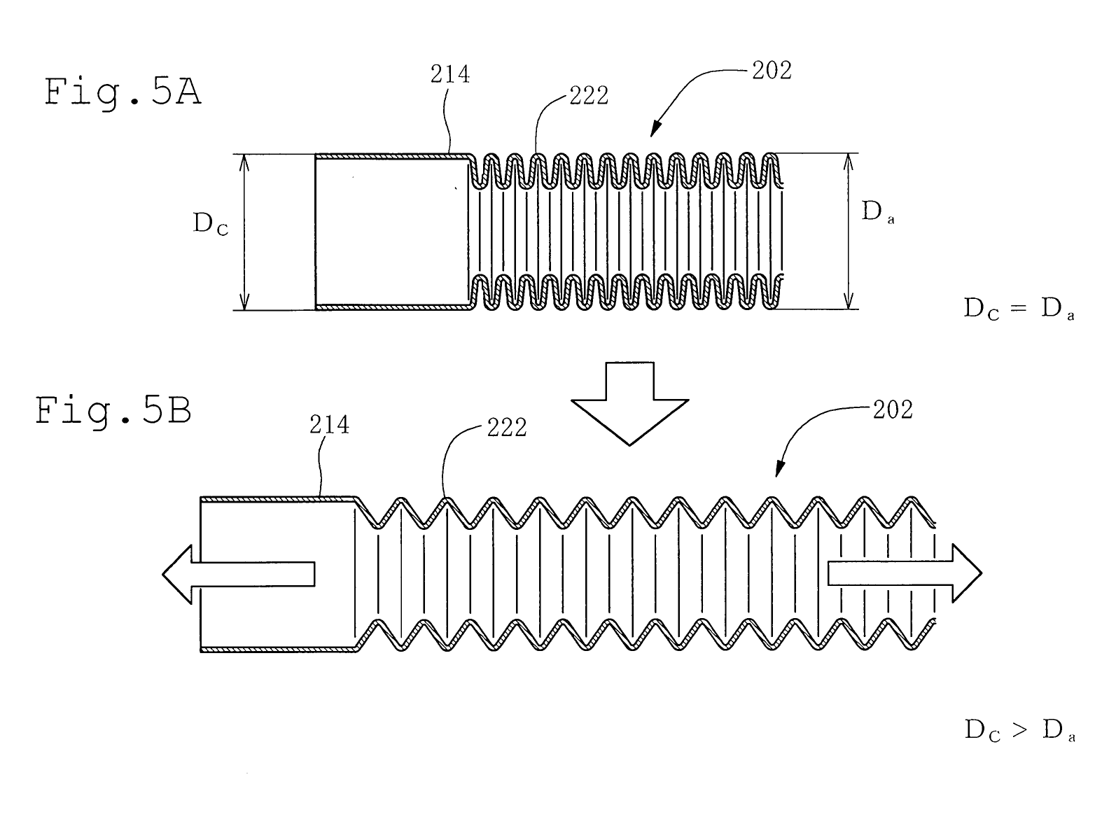

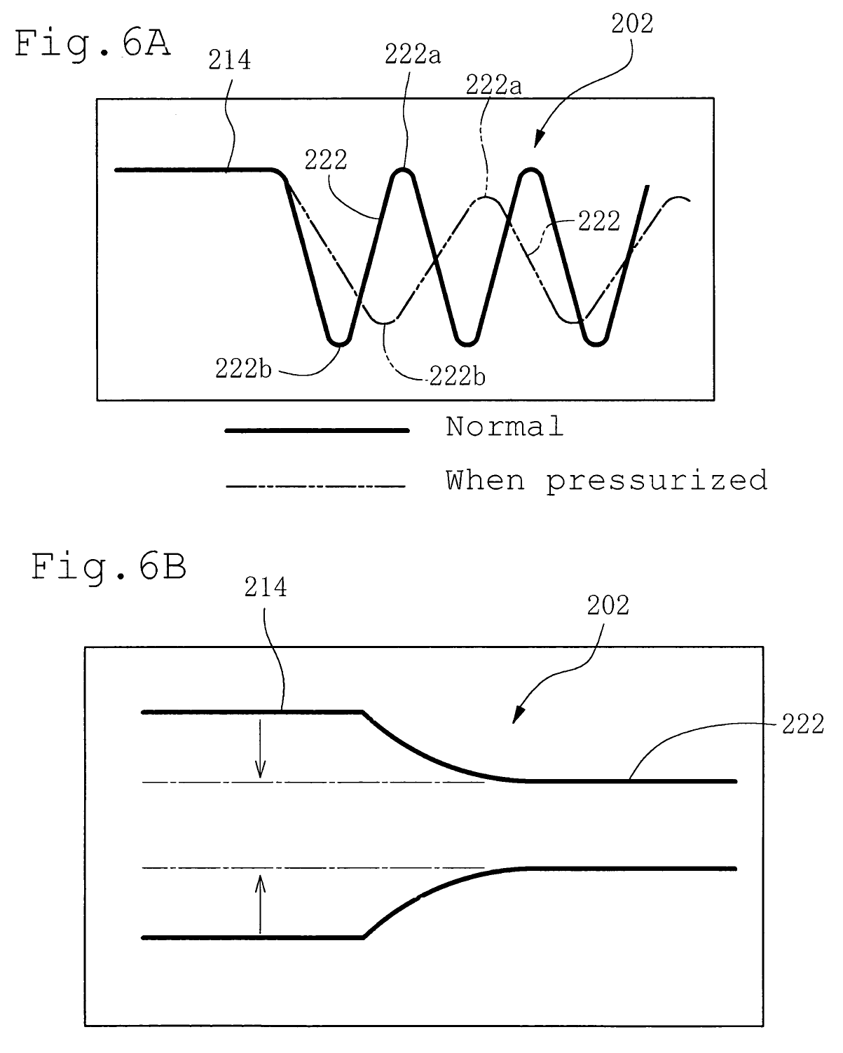

FIG. 3 illustrates another embodiment of the present invention.

In this embodiment, outer circular projections 40, as shown in FIG. 3A, are formed radially extending from the circumference of the tip 36 of the insert pipe 14 axially spaced apart in alignment with alternating grooves 38 of the bellows portion 24 to prevent the bellows portion 24 from sliding in an axial direction.

The outer projections 40 on the circumference of tip 36 are given a pitch which corresponds to the pitch of the grooves 38 in the corrugations of the bellows portion 24.

When the corrugations in the bellows portion 24 are of a spiral geometry the inner circumferential grooves 38 are also spiral and projections 40 may likewise be spiral projections so that the spiral projections 40 will act as male ends to intermesh with the female grooves 38 in the bellows portion 24.

What is claimed is:

1) A hose comprising: a hose body having an inner layer composed of a bellow metallic tube and a jacket of at least one outer layer, with the hose body having a longitudinal edge at one end thereof; an insert pipe extending longitudinally into the hose body and a metallic sleeve compressing the jacket against the insert pipe at each of a plurality of pressure points disposed axially along the longitudinal edge of the hose body from said one end with said bellow metallic tube having a restricted end portion at one end thereof located forward of the last pressure point.

2) The hose as set forth in claim 1 wherein said restricted end portion of said bellow metallic tube lies at a located between the pressure point closest to the longitudinal edge end of the hose body and the last pressure point.

3) The hose as set forth in claim 1 wherein the bellows metallic tube has a straight tube portion integral to the bellows metallic tube representing the restricted end portion of the bellows metallic tube.

4) The hose as set forth in claim 2 wherein the bellows metallic tube has a straight tube portion integral to the bellows metallic tube representing the restricted end portion of the bellows metallic tube with the straight tube portion extending a distance from the longitudinal edge at said one end of the hose body to a point forward of the last pressure point.

5) The hose as set forth in claim 3 wherein said rigid insert pipe has a first section extending longitudinally into the hose body upon which the straight tube portion is mounted.

6) The hose as set forth in claim 4 wherein said rigid insert pipe has a first section extending longitudinally into the hose body upon which the straight tube portion is mounted.

7) The hose as set forth in claim 5 wherein said rigid insert pipe has a second section extending further into the hose body and into the bellows metallic tube upon which at least a portion of said bellows metallic tube is mounted.

8) The hose as set forth in claim 6 wherein said rigid insert pipe has a second section extending further into the hose body and into the bellows metallic tube upon which at least a portion of said bellows metallic tube is mounted.

9) The hose as set forth in claim 7 wherein the diameter of said first section is larger than the diameter of said second section.

10) The hose as set forth in claim 8 wherein the diameter of said first section is larger than the diameter of said second section.

11) The hose as set forth in claim 7 wherein said second section has a series of projections radially extending from the outer circumference of the insert pipe for meshing with the corrugations of said bellows metallic tube.

12) The hose as set forth in claim 8 wherein said second section has a series of projections radially extending from the outer circumference of the insert pipe for meshing with the corrugations of said bellows metallic tube.
